(19) United States
(12) Patent Application Publication
(10) Pub. No.: US 2026/0229867 A1
(43) Pub. Date: Aug. 6, 2026

(54) DROP CLAMP ASSEMBLY

(71) Applicant: Allied Bolt, LLC, Bessemer, AL (US)

(72) Inventors: Roberto Sirotich, Boyton Beach, FL (US); Glen K. Malin, Purchase, NY (US)

(21) Appl. No.: 19/336,939

(22) Filed: Sep. 23, 2025

Related U.S. Application Data
(60) Provisional application No. 63/752,303, filed on Jan. 31, 2025.

(51) Int. Cl. H02G 7/05

(52) U.S. Cl. CPC H02G 7/056

(57) ABSTRACT

A drop clamp that comprises a shim and a wedge member. A body portion of the shim has a tab extending outward from a first side of the shim. The tab has an upper section and lower section between the upper section and the body portion. The wedge member has opposing sidewalls and a base therebetween which define an interior channel. The base has a slotted opening through the base extending longitudinally along its length. The shim and wedge member are capable of being slidingly secured to one another whereby the tab is inserted through the slotted opening with the lower section being between interior side edges of the opening and the upper section extending into the interior channel. The upper section of the tab being rotated with a bottom edge of the upper section engaging against the first side of the base of the wedge member.

### CROSS-REFERNCE TO RELATED APPLICATIONS

The present application claims the benefit of, priority to, U.S. Provisional Patent Application No. 63/752,303 filed Jan. 31, 2025, the entire contents of which are hereby incorporated by reference in their entirety as if set forth fully herein.

### FIELD

Embodiments presented herein relate generally to a drop clamp assembly for securing fiber drop wires or cables to a support structure, and more particularly to a drop clamp assembly that can be secured to a wire or cable in the field by a two-piece connection.

### BACKGROUND

Drop wire clamps, or drop clamps, are generally known to be used for supporting aerial/overhead power and telecommunication lines that link communication networks to internal building systems. Such clamps can secure cables to anchor points along walls or facades of buildings or poles by griping the cable within a body portion of the clamp, with a bail wire of the clamp holding the cable in place with a specific level of tension to prevent excessive sagging or strain on the connection points.

Traditional drop clamp assemblies require a field connection of individual components such as a wedge with integral bail wire, shell, and shim. More particularly, a cable customarily will be manually inserted through an interior channel of the shell and the shim will be aligned and placed over the cable within the channel of the shell. While holding the shim in place in the proper alignment within the shell, a field worker will then typically insert the wedge into the shell over the shim and cable and pull bail wire sliding the wedge through the shell until the wedge and shell become frictionally engaged with the wedge becoming lodged within the shell thus gripping the clamp around the cable with the bail wire extending therefrom. The bail wire is then typically secured to the anchor of the holding the cable in tension.

As described above, in making the connection between the clamp and the cable, a line worker will need to manage, position and hold three separate pieces of the clamp (in addition to the cable itself). Such connection process can be cumbersome, complex and time-consuming in order to manipulate the pieces into a precise alignment to form a secure attachment. Such difficulty can be compounded in harsh or confined conditions including where such work is being performed on elevated utility poles or mid-spans, at densely packed support structures or in dark, windy or frigid environmental conditions when line workers are wearing gloves or other equipment that can make handling the components more difficult. Such difficulties can lead to increased labor costs and higher chances of installation errors, which may compromise the stability and longevity of the connection. Often shims are dropped by an installer and the installer proceeds to install the clamp without the shim, thereby making the clamp less effective.

Given these challenges, there is a clear need for an improved drop clamp assembly that simplifies the installation process and reduces the potential for errors, ultimately ensuring a more secure and reliable connection in diverse field conditions.

### BRIEF DESCRIPTION OF THE DRAWINGS

FIG. 1A is a schematic top plan view of a drop clamp assembly according to embodiments representatively presented herein.

FIG. 1B is a schematic side elevation view of the drop clamp assembly of FIG. 1A according to embodiments representatively presented herein.

FIGS. 1C and 2D are opposing schematic end elevation views of the drop clamp assembly of FIG. 1A according to embodiments representatively presented herein.

FIG. 2A is a schematic top plan view of a shell member of a drop clamp assembly according to embodiments representatively presented herein.

FIG. 2B is a schematic side elevation view of the shell member of FIG. 2A according to embodiments representatively presented herein.

FIG. 2C is a schematic bottom plan view of the shell member of FIG. 2A according to embodiments representatively presented herein.

FIGS. 2D and 2E are opposing schematic end elevation views of the shell member of FIG. 2A according to embodiments representatively presented herein.

FIGS. 2F and 2G are opposing schematic end elevation views of the shell member according to embodiments representatively presented herein.

FIG. 3A is a schematic top plan view of a wedge member of a drop clamp assembly according to embodiments representatively presented herein.

FIG. 3B is a schematic side elevation view of the wedge member of FIG. 3A according to embodiments representatively presented herein.

FIGS. 3C and 3D are opposing schematic end elevation views of the wedge member of FIG. 3A according to embodiments representatively presented herein.

FIG. 4 is a schematic top plan view of a bail wire according to embodiments representatively presented herein.

FIG. 5A is a schematic side elevation view of a shim member of a drop clamp assembly according to embodiments representatively presented herein.

FIG. 5B is a schematic top plan view of the shim member of FIG. 5A according to embodiments representatively presented herein.

FIG. 5C is a schematic enlarged side elevation view of a portion of the shim member indicated as detail J in FIG. 5A.

FIG. 5D and 5E are schematic cross-section views of the shim member of FIG. 5A, taken along the lines B-B and H-H, respectively.

FIG. 6A is a schematic perspective view of the wedge member and shim members of the drop clamp being positionally aligned for being secured to one another according to embodiments representatively presented herein.

FIG. 6B is a schematic perspective view of the wedge member and shim members of the drop clamp in position to be secured to one another according to embodiments representatively presented herein.

FIG. 6C is a schematic perspective view of the wedge member and shim members of the drop clamp secured to one another as a one-piece structure according to embodiments representatively presented herein.

FIG. 6D is a schematic top plan view of the wedge member and shim members of the drop clamp secured to one another as a one-piece structure according to embodiments representatively presented herein.

### DETAILED DESCRIPTION

While the subject invention is susceptible of embodiment in many different forms, there are shown in the drawings, and will be described herein in specific detail, embodiments thereof with the understanding that the present disclosure is to be considered as an exemplification of the principles of the invention and is not intended to limit the invention to the specific embodiments illustrated.

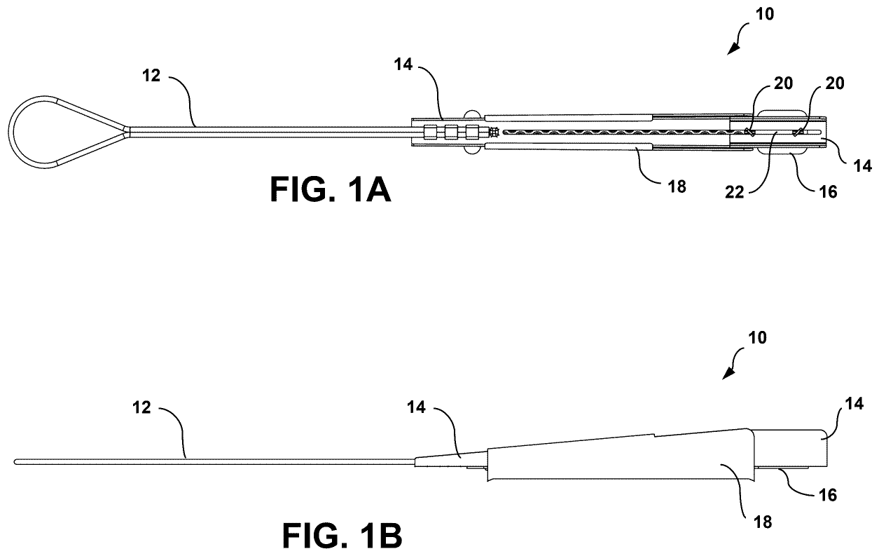

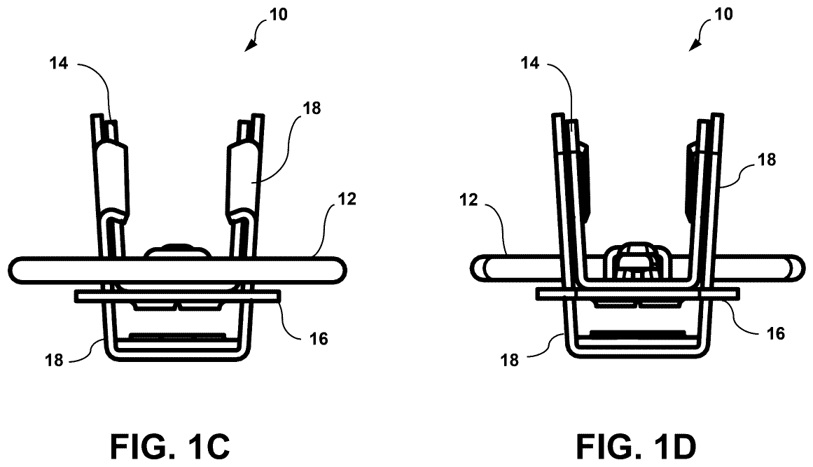

With reference now to the figures, FIGS. 1 through 1D illustrate a drop clamp assembly 10 according to embodiments representatively presented herein. As shown schematically in FIGS. 1A through 1D, drop clamp assembly 10 can comprise a joined-together first piece comprising a bail wire 12, wedge member 14 and shim 16 and a second piece comprising a shell member 18. According to embodiments shown representatively in FIGS. 1A through 1D, at least a portion of the first piece comprising the wedge member 14 and shim 16 are configured to engage within and slide along an interior channel of the second piece comprising the shell member 18.

As further shown schematically in FIGS. 1A and 1B, bail wire 12 can be secured to a first tapered end of wedge member 14 and shim 16 can be secured along the bottom of wedge member 14 by way of tabs 20 that can extend through a slotted opening 24 in the bottom of wedge 14—such connection enabling the tabs 20 to slide along the slotted opening 22 to enable the shim 16 to slidingly engage along the bottom of wedge 14. According to embodiments shown representatively in FIGS. 1A and 1B, the elements of the first piece, namely the bail wire 12, wedge member 14 and shim 16 can be joined together prior to the drop clamp 10 being field installed to a cable. To best withstand tension exerted on the clamp and environmental conditions, the clamp portion of drop clamp assembly 10, including the shell 18, shim 16 and wedge member 14 can be stamped from high-strength stainless steel, and the bail wire 12 can be form from soft stainless steel, however other durable materials can be used without limitation.

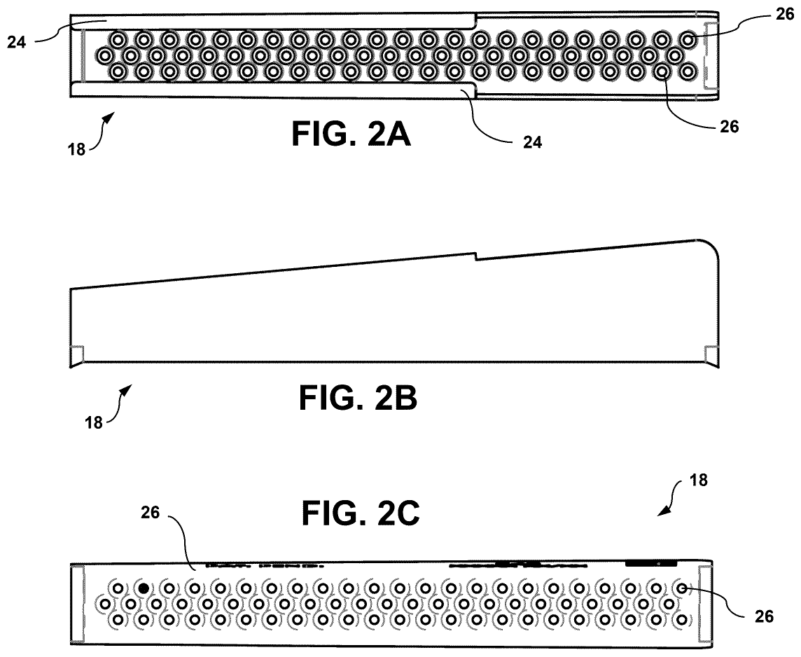

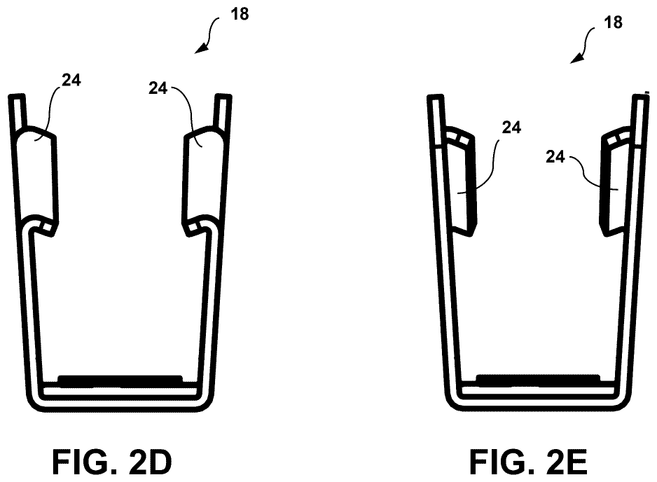

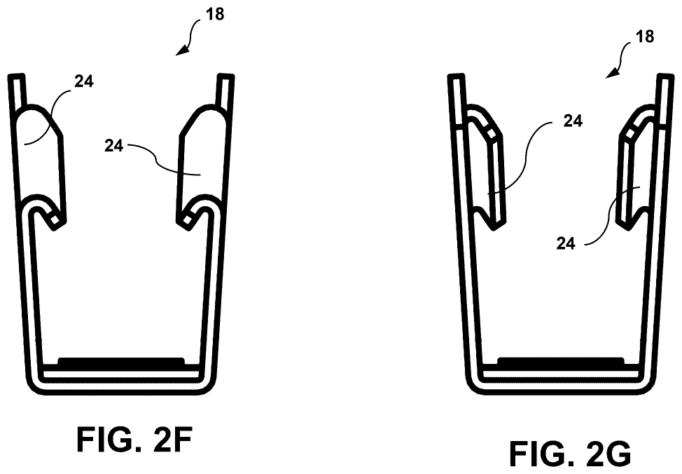

FIGS. 2A through 2E illustrates a shell 18 for use with the drop clamp assembly 10 according to embodiments representatively presented herein. As shown schematically in the views of FIGS. 2A through 2E, shell 18 can have an elongated length between opposing first and second ends and comprise a generally U-shaped configuration in section formed by a substantially level base and opposing raised side sidewalls that can angle slightly outward as they extend upward and away from the base. The sidewalls and base of shell 18 can form an interior channel therebetween.

As best shown in the side elevation view of FIG. 2B, the sidewalls of the shell can gradually increase in height as they extend along the length of the shell from the first end to the second end. As best shown in FIG. 2A together with the end elevation views of FIGS. 2D and 2E, flanges 24 can be integrally formed along at least a portion of the top edge of each of the opposing sidewalls of shell 18. Flanges 24 can extend inward toward the interior channel of the shell and have a hooked or bent configuration with a bottom retaining surface. FIGS. 2F and 2G illustrate a shell 18 according to another representative embodiment where flanges 24 extend further inward toward the interior channel of the shell to provide a bottom retaining surface with a deeper hook or groove between the interior surface of the flange and the interior side of the adjacent corresponding sidewall.

As best shown in the top and bottom plan views of FIGS. 2A and 2C, the base of shell 18 can have a coarse or serrated surface comprised of a pattern of small sharp, tooth-like serrations in the nature of projections, teeth or notches 26. As will further understood from the following description, such serrations 26 are intended to increase friction between the base of shell 18 and a cable inserted along the interior channel thereof between the top surface of the base of shell 18 and the shim 16 affixed along the underside of wedge member 14 to facilitate secure hold or grip of the cable between the top surface of the base of the shell 18 and the bottom of the shim 16.

As shown representatively in FIG. 2A, flanges 24 extend along only a first portion of the length of shell 18, with a second portion adjacent to the first portion, having sidewalls without the flanges extending therefrom, thus providing wider access to the interior channel of the shell. According to embodiments presented herein, the second portion of the shell can be the insertion point for the wedge member 14 for engagement within the shell, and once the wedge member is inserted, the shell 18 and wedge member can be manipulated so that the wedge member travels into the first portion of the shell with the top edges of the wedge member engaging along the bottom retaining surface of the flanges 24.

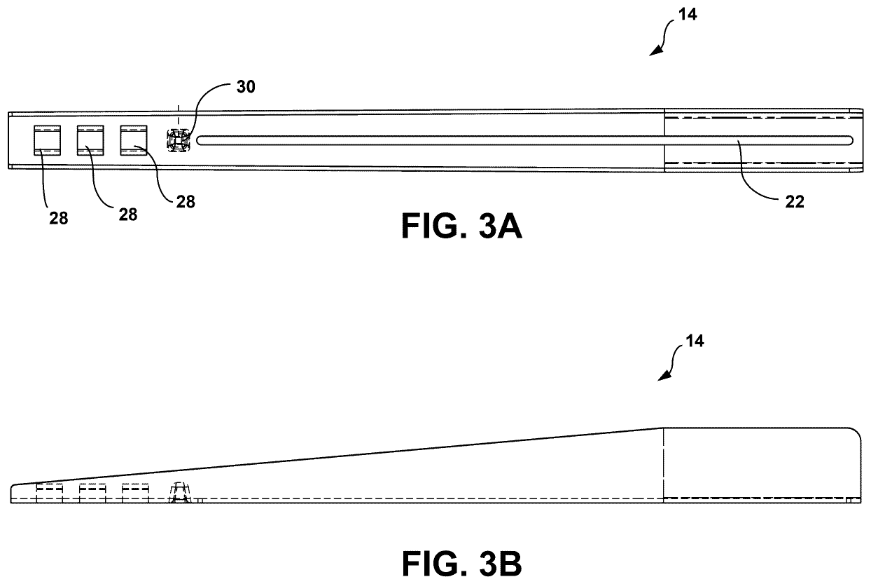

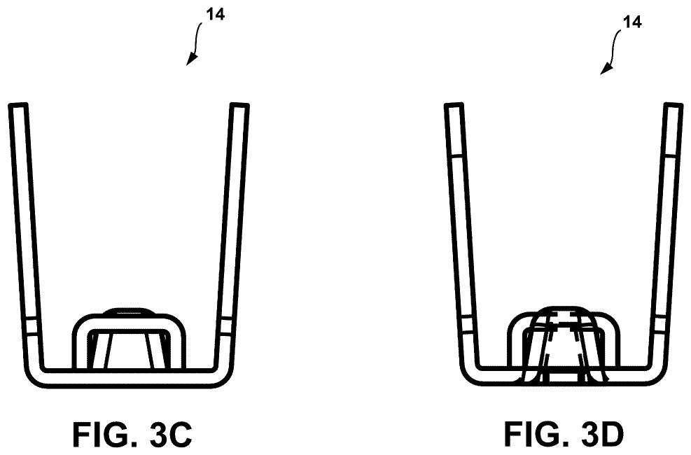

FIGS. 3A through 3D illustrate a wedge member 14 of drop clamp assembly 10 according to embodiments representatively presented herein. As shown schematically in the views of FIG. 3, the wedge (mirroring the configuration of the shell 18 as shown and described in FIGS. 2A through 2E) can have an elongated length between opposing first and second ends and comprise a generally U-shaped configuration in section formed by a substantially flat/lateral base and opposing raised sidewalls that can angle slightly outward as they extend upward and away from the base. The sidewalls and base of wedge member 14 can form an interior channel therebetween.

As best shown in the side elevation view of FIG. 3B, the opposing sidewalls of wedge member 14 can gradually increase in height as they extend along at least a portion of the length of the wedge member from the first end towards the second end but can plateau or level out in height at a portion adjacent the second end of the wedge as shown in the side elevation of FIG. 3B such that the top terminal edges of the sidewalls adjacent the second end of wedge 18 are substantially parallel with the bottom surface of the wedge. As best shown in the top plan view of FIG. 3A, at least a portion of the base of wedge member 14 can have a slotted opening 24 formed therethrough. The slotted opening 24 can have an elongated length extending from a location adjacent the second end of the wedge member 14 towards the first end thereof.

The wedge member 14 can comprise a plurality of brackets 28 along the interior of the base and adjacent the first end of the wedge member. According to embodiments presented herein, prior to installation of the drop clamp in the field, such brackets can be configured for receiving a proximal straight end of the bail wire 12 and can be mechanically crimped to compress against and secure the bail wire 12 to the wedge member 14 such that the bail wire extends from the first end thereof. As shown schematically in FIG. 3A, the base of wedge 14 can also comprise a raised projection 30 between brackets 28 and the slotted opening 22. According to embodiments representatively presented herein, projection 30 can act as a stop for bail wire 12 to ensure that bail wire is appropriately positioned within the interior channel of wedge 14 so as not to interfere with the slotted opening 24. More particularly, upon affixing the bail wire 12 to wedge 14, a proximal end of bail wire 14 can be inserted along the base of the internal channel of wedge until it contacts projection 30, and once such connection is made brackets 28 can be crimped around bail wire 14 securing it to the wedge 14.

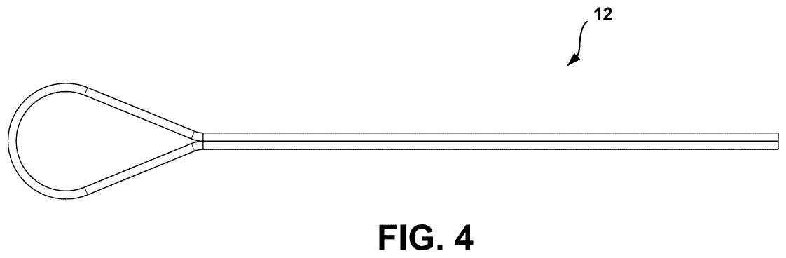

FIG. 4 illustrates a bail wire 12 of the drop clamp assembly 10 according to embodiments representatively presented herein. As shown schematically in FIG. 4, the bail wire 12 can be comprised of a ridged wire rod having a straight proximal end and a loop at the opposing distal end. According to embodiments representatively presented herein, the ends of the wire rod 12 can be joined together and extend substantially parallel to one another from the proximal end and a middle portion of the wire rod can be curved to form the loop at the distal end of the bail wire 12. As described previously in relation to FIG. 3A, the proximal end of the bail wire can be secured to the tapered first end of the wedge member 14 prior to installation of the drop clamp 10 in the field, and during installation, the loop at the distal end can be coupled to an anchor of a support structure to hold the clamp 10 and aerial cable in tension.

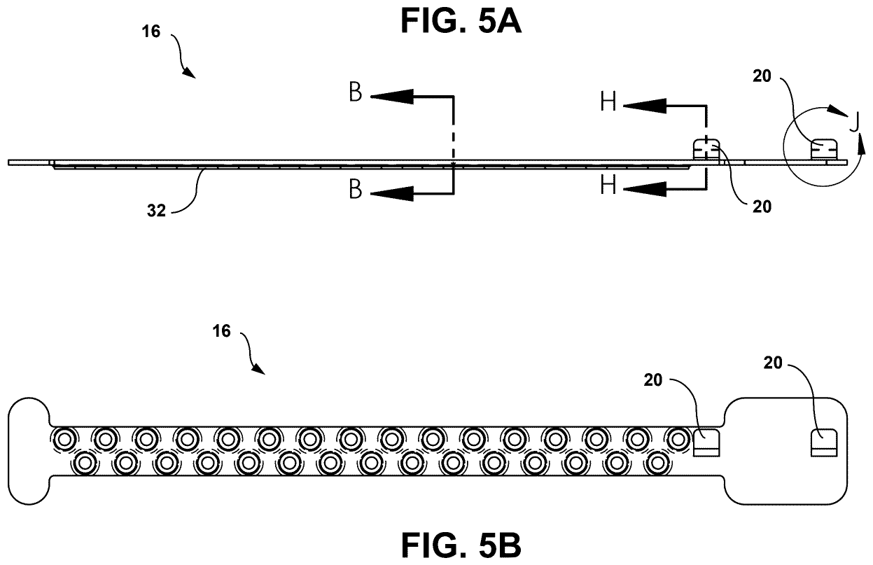

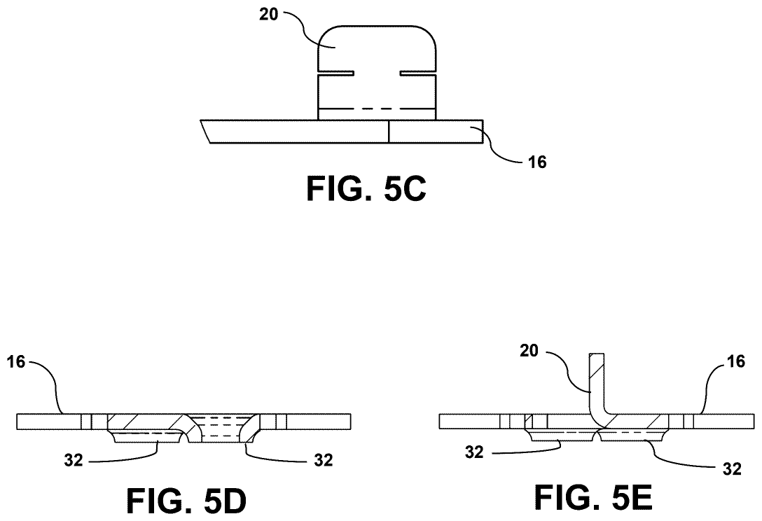

FIGS. 5A through 5E illustrate a shim 16 of the drop clamp assembly 10 according to embodiments representatively presented herein. As shown schematically in the views of FIGS. 5A and 5B, shim 16 can comprise a substantially flat body portion having opposing top and bottom surfaces and an elongated length between opposing first and second ends. According to embodiments best shown representatively in the top plan view of FIG. 5B, shim 16 can have a generally “dog-bone” shape having a middle portion between opposing end portions whereby the middle portion has a narrower width than that of the end portions adjacent the opposing respective first and second ends.

As best shown in FIGS. 5A and 5B, a plurality of rotatable tabs 20 can extend substantially perpendicularly upward from the upper side of the shim 16. The tabs 20 can be proximate the second end of the shim 18. According to embodiments representatively presented herein, tabs 20 can have a generally flat orientation comprising sides having length extending in a direction parallel to the length of shim 18 and a narrower width therebetween. As described above, such tabs 20 can be configured for being inserted within the slotted opening 22 in the bottom of the wedge member 14, and can be rotated to slidably engage the shim 16 to the wedge 14.

As shown in the detail view of FIG. 5C, tabs 20 can extend upward from the top surface of the shim 16 and can have a lower section adjacent the body of shim 16 and an upper section above the lower section opposite the shim body. According to embodiments representatively presented herein, the upper and lower portions of tabs 20 can be joined by a neck portion that can act as a hinge to facilitate the rotation of the upper section of tabs relative the lower section. Accordingly, in use when tabs 20 are inserted through the slotted opening 22 along the base of wedge 14, the lower section of tabs 20 can be positioned between the side edges of the slotted opening 22 with the upper section of tabs 20 extending into the interior channel of wedge 14. Upon rotation of the upper section of tabs 20, the bottom surface of the upper section can engage against the top surface of the base of wedge 14. Such engagement can retain the top section of tabs within the interior channel of wedge 14 to secure the shim 16 to the wedge 14. According to embodiments presented herein, such engagement can be slidable such that the lower section of tabs 20 that are positioned between the side edges of the slotted opening 22 can slide along the length of the slotted opening to facilitate slidable movement of the shim 16 relative the wedge. Such slidable engagement can facilitate an improved friction fit between the shim 16 and a cable secured to the drop clamp assembly 10.

According to embodiments representatively presented herein and best shown in FIGS. 5D and 5E, the bottom surface of shim 16 can have a coarse or serrated surface comprised of a pattern of small sharp, tooth-like projections or notches 32. As described above in connection with the shell shown in FIGS. 2A through 3E, when the wedge member 14 is slidingly engaged within the shell the serrations on the bottom surface of the shim 16 are intended to increase friction between the shim/wedge piece 16, 14 and cable inserted within shell 18. Such friction can ensure a secure hold or grip between the shell and the cable that comprise the first piece of the drop clamp assembly 10. Although the figures of the subject application depict the serrations as comprising a pattern of circular projections, it will be understood that such serrations can have alternate shapes, sizes, orientations or patters without departing from the scope of embodiments presented herein.

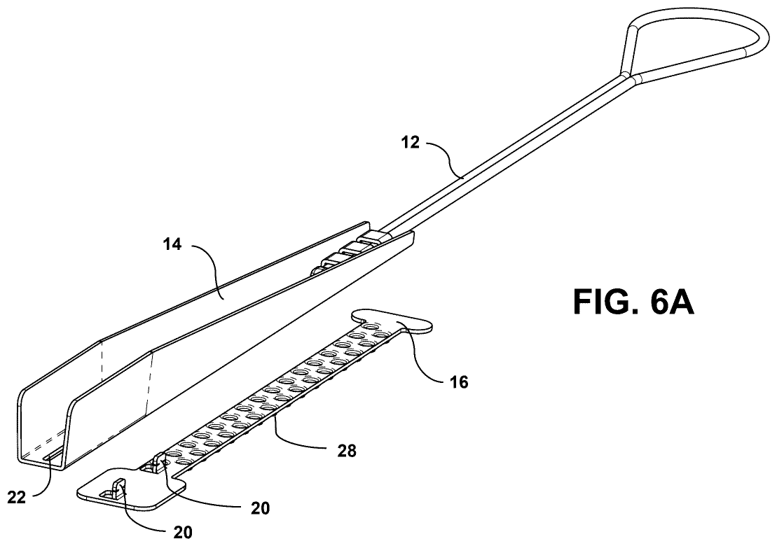

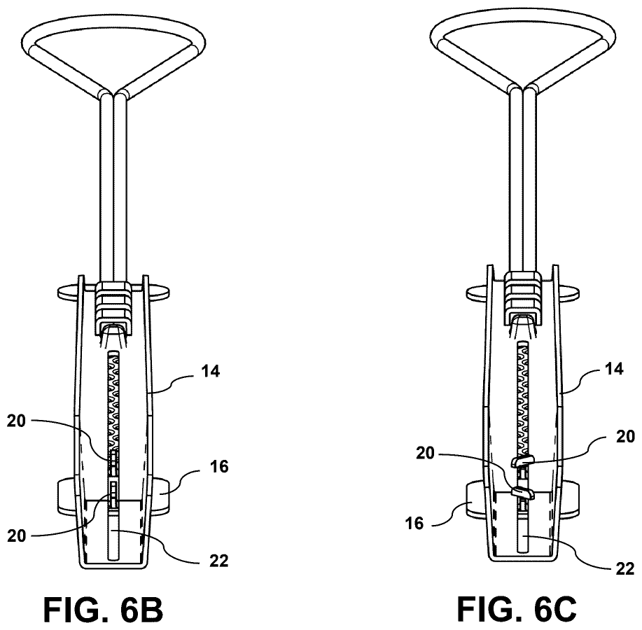

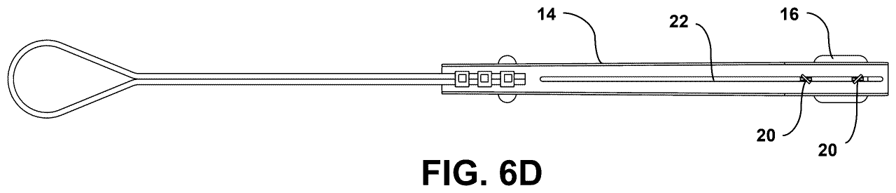

FIGS. 6A through 6D representatively illustrate a connection sequence for securing wedge member 14 and shim 16 members together to form a one-piece structure in accordance with embodiments presented herein. More particularly, FIG. 6A is a first perspective view illustrating the shim 16 and wedge 14 in alignment with one another prior to engagement. As shown schematically in FIG. 6A, in joining the shim 16 to the wedge member 14 with a bail wire 12 coupled thereto, shim 16 can be aligned below the underside of the base of wedge 14 such that the tabs 20 of shim 16 are oriented to extend upward toward the underside of the base of wedge 14 and in alignment with the slotted channel 22 through the base. In such orientation, the serrations 32 along the bottom surface of shim 16 can be orientated to project downward away from the wedge 14.

FIG. 6B through 6D illustrate shim 16 and wedge member 14 being positioned together for engagement as a one-piece structure. More particularly, as shown in FIG. 6B, the top side of shim 16 can be positioned flush against the bottom surface of the base of wedge 14 and the upwardly extending tabs 20 of the shim can be inserted through the slotted opening 22 along the base of wedge 14. As shown in FIGS. 6C and 6D, once tabs 20 of the shim 16 are inserted within the slotted opening 22 of the wedge member 14, the upper/distal section of the tabs 20 can be rotated about the hinged neck portion as shown in FIGS. 6C and 6D. Upon being rotated, the bottom surface of the upper section of tabs 20 can engage against the top surface of the base of wedge 14. Such engagement can retain the top section of tabs within the interior channel of wedge 14 to secure the shim 16 to the wedge member 14 with the lower section of tabs 20 being positioned between the side edges of the slotted opening 22 to facilitate slidable movement of the shim 16 relative the wedge 14. Thus, once joined with the wedge member 14 the shim 16 can be permitted slide along at least a portion of the length of the bottom of the wedge 14 with such sliding movement being guided by engagement of the lower section of the tabs 20 within the slotted opening 22.

From the foregoing it will be appreciated that the assembly of the first piece of the drop clamp 10 (comprising the bail wire 12, wedge 14, shim 16) can be undertaken prior to installing the drop clamp 10 in the field, and thus during installation a field worker will only have to handle two pieces of the drop clamp instead of three (or more). More particularly, in use a line worker can insert an aerial drop wire through the interior channel of shell 18, and once inserted align the first piece of the drop clamp 10 with the shell 18 by positioning the first tapered end of the wedge 14 with the second end of the shell 18 that has taller/larger sidewalls forming a deeper interior channel.

According to embodiments presented herein, once the first piece of the clamp and shell 18 are aligned, the wedge member 14 of the first piece can be pulled or slid into the shell 18 with the drop cable positioned between the serrated bottom surface of the shim 16 and the serrated upper surface along the interior channel of the shell 18. More particularly, in pulling or sliding the wedge member 14 into the shell, the top edges of the tapered sidewalls of the wedge member 14 can engage with the retaining surface along the underside of the flanges 24 along the top of sidewalls of the shell 18 and as wedge 14 slides into the shell 18, the thicker sidewalls of wedge 14 within the interior channel of the shell 18 will cause the wedge to get frictionally jammed within the shell 18 with the retaining surfaces of the flanges 24 of the shell 18 maintaining the wedge 14 within the shell 18 causing the drop cable to be securely clamped between the serrated surface 32 along the underside of the shim 16 and the serrations 26 along the inside surface channel of the shell 18. Such friction fit (together with the tension force from securing the bail wire to an anchor) can secure the clamp 10 to the cable and facilitate the cable being suspended above the ground.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be added to, or removed from the described embodiments.

What is claimed is:

1. A drop clamp comprising:
a shim comprising a body portion having opposing first and second sides and a length between first and second longitudinal ends, a tab extending outward from the first side of the body portion, the tab comprising opposing first and second sides and upper and lower sections, the lower section being between the upper section and the body portion of the shim, the upper section of the tab being rotatable relative the lower section;
a wedge member comprising opposing sidewalls and a base therebetween, the opposing sidewalls of the wedge member extending from the base, and with the base defining an interior channel along at least a portion of a length of the wedge member, the base having opposing first and second sides and a slotted opening extending longitudinally along at least a portion of its length, the slotted opening extending through the base between the opposing first and second sides of the base and having interior side edges, and
wherein the shim and wedge member are configured to be slidingly secured to one another to form a once-piece structure for securing the drop clamp to a cable, wherein the tab of the shim is configured for being inserted through the slotted opening along the base of the wedge member with the lower section of the tab being positionable between the interior side edges of the slotted opening and the upper section of the tab extending into the interior channel of the wedge member, the upper section of the tab being rotated relative the bottom section with a bottom edge of the upper section of the tab engaging against the first side of the base of the wedge member, the lower portion of the tab being slidable within the slotted opening between the interior side edges.

2. The drop clamp of claim 1 wherein the tab comprises a plurality of tabs.

3. The drop clamp of claim 1 wherein the second side of the shim has a serrated surface comprising a plurality of projections extending outwardly therefrom.

4. The drop clamp of claim 1 wherein the base and opposing sidewalls of the wedge member are substantially straight, the wedge member having a U-shaped cross-sectional profile.

5. The drop clamp of claim 1 wherein the opposing sidewalls of the wedge member taper in height as they extend from a first end of the wedge member to an opposing second end of the wedge member.

6. The drop clamp of claim 1 further comprising a bail wire, the bail wire being securable to a second end of the wedge member.

7. The drop clamp of claim 1 wherein the shim has a dog-bone orientation having end segments at each of the first and second longitudinal ends and a middle segment therebetween, whereby the end segments have a larger width than the middle segment.

8. The drop clamp of claim 1 further comprising a shell having first and second ends and opposing space-apart sidewalls with a base therebetween, the base and opposing spaced-apart sidewalls of the shell defining an interior channel therebetween, the opposing spaced apart sidewalls of the shell tapering in height as they extend from the first end to the second end of the shell, the opposing sidewalls of the shell having terminal edges opposite the base of the shell, a flange extending along at least a portion of the terminal edges of the opposing sidewalls, the flange extending inward into the interior channel of the shell and providing a retaining surface along the underside thereof, the retaining surface being configured for engagement with terminal edges of the opposing sidewalls of the wedge member.

9. The drop clamp of claim 6 wherein the bail wire has a proximal end and a terminal end, the proximal end being substantially straight and the terminal end forming a loop, a bracket being provided proximate the second edge of the wedge member, the bracket being configured for receiving the proximal end of the bail wire and coupling the bail wire to the wedge member.

10. The drop clamp of claim 8 wherein the base along the interior channel of the shell has a serrated surface comprising a plurality of projections extending therefrom.

11. The drop clamp of claim 8 wherein the base and sidewalls of the shell are substantially straight, the shell having a U-shaped cross-sectional profile.

12. A drop clamp comprising:
a shim comprising a body portion having opposing first and second sides and a length between first and second longitudinal ends, a plurality of tabs extending outward from the first side of the body portion, each of the plurality of tabs comprising opposing first and second sides and upper and lower sections, the lower section being between the upper section and the body portion of the shim, the upper section of each of the plurality of tabs being rotatable relative the lower section, the second side of the shim having a serrated surface comprising a plurality of projections extending outwardly therefrom;
a wedge member comprising substantially straight opposing sidewalls and a substantially flat base therebetween, the opposing sidewalls of the wedge member extending from the base, and with the base defining an interior channel along at least a portion of a length of the wedge member, the opposing sidewalls of the wedge member tapering in height as they extend from a first end of the wedge member to an opposing second end of the wedge member, the base having opposing first and second sides and a slotted opening extending longitudinally along at least a portion of its length, the slotted opening extending through the base between the opposing first and second sides of the base and having interior side edges,
a shell having first and second ends and opposing substantially straight space-apart sidewalls with a substantially flat base therebetween, the base and opposing spaced-apart sidewalls of the shell defining an interior channel therebetween, the opposing spaced apart sidewalls of the shell tapering in height as they extend from the first end to the second end of the shell, the opposing sidewalls of the shell having terminal edges opposite the base of the shell, a flange extending along a first portion of the terminal edges of the opposing sidewalls, the flange extending inward into the interior channel of the shell and providing a retaining surface along the underside thereof, a second portion of the of the terminal edges of the opposing sidewalls defining an area for engagement of the wedge member within the shell, the retaining surface being configured for engagement with terminal edges of the opposing sidewalls of the wedge member, the base along the interior channel of the shell having a serrated surface comprising a plurality of projections extending therefrom, and
wherein the shim and wedge member are configured to be slidingly secured to one another to form a one-piece structure for securing the drop clamp to a cable, wherein the plurality of tabs are configured for being inserted through the slotted opening along the base of the wedge member with the lower section of each of the plurality of tabs being positionable between the interior side edges of the slotted opening and the upper section of each of the plurality of tabs extending into the interior channel of the wedge member, the upper section of each of the plurality of tabs being rotated relative the bottom section with a bottom edge of the upper section of each of the plurality of tabs engaging against the first side of the base of the wedge member, the lower portion of each of the plurality of tabs being slidable within the slotted opening between the interior side edges.

13. A method of securing a drop clamp to a cable, the method comprising:
providing a shim comprising a body portion having opposing first and second sides and a length between first and second longitudinal ends, a tab extending outward from the first side of the body portion, the tab comprising opposing first and second sides and upper and lower sections, the lower section being between the upper section and the body portion of the shim, the upper section of the tab being rotatable relative the lower section;
aligning the shim with a wedge member having opposing side walls with a base therebetween, a slotted opening extending longitudinally along at least a portion of a length of the base, the slotted opening extending through the base of the wedge member between opposing first and second sides of the base and having interior side edges;
inserting the tab of the shim into the slotted opening of the wedge member;
rotating the upper section of the tab relative the lower section, a bottom edge of the upper section of the tab engaging against the first side of the base of the wedge member, the wedge member and shim being coupled as a joined one-piece structure;
inserting a cable through an interior channel of a shell of the drop clamp, the interior channel of the shell being defined by a base and opposing sides extending from the base of the shell, the cable extending through the interior channel of the shell between the opposing sides;
inserting at least a portion of the wedge member of the one-piece structure into the interior channel of the shell, cable being positioned between the shim and the base of the interior channel of the shell;
sliding the one-piece structure and shell relative each another;
sliding the tab of the shim along the slotted opening of the wedge member, the lower section of the tab sliding between the interior side edges of the slotted opening, and
securing the drop clamp to the cable by way of a frictional engagement whereupon at least a portion of the top edges of each of the opposing sides of the wedge member are engaged along a retaining surface defined by a flange along at least a portion of the opposing sides of the shell.
